(19) United States
(12) Patent Application Publication
(10) Pub. No.: US 2023/0150845 A1
(43) Pub. Date: May 18, 2023

(54) ELECTROLYTIC REACTORS

(71) Applicant: Fraunhofer-Gesellschaft zur Förderung der angewandten Forschung e.V., München (DE)

(72) Inventors: Sebastian Krupp, Stuttgart (DE); Michael Bohn, Stuttgart (DE); Siegfried Egner, Adelsheim (DE)

(21) Appl. No.: 17/967,017

(22) Filed: Oct. 17, 2022

(30) Foreign Application Priority Data
Oct. 21, 2021 (DE) 10 2021 127 350.1

(51) Int. Cl. C02F 1/461

(52) U.S. Cl. CPC C02F 1/46109; C02F 2001/46133; C02F 2001/007

(57) ABSTRACT

The invention relates to an electrolytic reactor, in particular for separating phosphate from phosphate-containing liquids and/or recovering phosphate salts, comprising an inlet (16) for an electrolysis liquid and a flow channel (20) adjoining same, a magnesium metering unit (12) comprising two electrodes (22, 24) of different polarity being arranged in the flow channel (20), at least one of the two electrodes (22, 24) being a sacrificial electrode (20), wherein the magnesium metering unit (12) is designed as a free-level reactor and a mixing/sedimentation unit (14) being connected downstream of the magnesium metering unit (12) in the direction of flow, said mixing/sedimentation unit having a feed inlet (40) for the phosphate-containing liquids and an outlet (26) for the purified liquid for the obtained phosphate product.

### BACKGROUND OF THE INVENTION

In process engineering, electrolytic reactors are used for the precipitation and/or recovery of phosphorus from phosphate-containing liquids, for example from process water or wastewater, in the following process water or electrolyte. These have a cathode and an anode. During operation of the reactor, an electrical voltage is applied between the cathode and the anode, the anode being consumed (sacrificial anode). The sacrificial anode is usually made of magnesium. One of the electrodes is arranged above and the other below a reaction space or ion metering chamber, which is filled with process water as the electrolyte.

The elements nitrogen and phosphorus are essential substances for plant growth, besides other elements. These are usually contained as ions in solid or liquid organic waste or wastewater. In order to treat this waste or wastewater, for example municipal wastewater, these substances must be removed to protect the environment (eutrophication). Furthermore, in the interest of sustainability, it is also important to recover them and to make them available again as plant fertilizer, for example. It is therefore necessary to convert nitrogen and phosphate into an inorganic form suitable for use, for example as fertilizer, for example by precipitation as MAP. Phosphate salts such as magnesium ammonium phosphate (MAP) are high-quality plant growing aids for which there is high demand.

DE 10 2010 050 691 B3 and DE 10 2010 050 692 B3 describe a method and a reactor for recovering phosphate salts from a liquid, the sacrificial electrodes consisting of a magnesium-containing material.

Further methods for obtaining phosphate salts are disclosed in DE 10 2014 207 842 C2 and also in DE 10 2016 109 824 A1.

However, a disadvantage of the known devices and methods is that not only the sacrificial anode, but all current-conducting metal parts which come into contact with the electrolyte and which are polarized in an electrical field are exposed to the electrolysis. This means that all bare metal points in the reactor which are associated with the contacting also act as a sacrificial anode at a corresponding polarity.

The consequences at the upper electrode are that metal fastening parts, such as screws for fastening the contact cables, lose their threads or become loose in extreme cases.

Other contact elements, such as cable shoes, become released. The consequences at the lower electrode are that pitting and corrosion or subsequently deformations occur on contact elements. This leads to deterioration and in places to loss of contacting. In addition, this increases the maintenance workload for the reactor, since the worn parts must be replaced.

Furthermore, unwanted precipitates are formed. At all contact points between the contacting element and the magnesium electrode, deposits are formed which mostly consist of magnesium hydroxide. After some time, the deposits between the contact elements and the lower electrode grow to form a coherent layer. Local material accumulations form at the individual contacting points of the upper electrode. These material accumulations can also develop between contact elements, such as contact plates, and the electrode, and often leave cavities in the electrode at their point of origin.

Further disadvantages consist of the risk of overflow over the upper electrode, since there is a gap between the cover of the reactor and the upper magnesium electrode due to the design. Due to the consumption of the electrodes, this gap becomes steadily larger during operation. In order to prevent short-circuit flows between the cover and the electrode, this variable dead space must be closed. This requires additional structural elements.

The process water to be treated flows through the electrical field between the anode and the cathode. Here, the released magnesium ions pass into a solution. Due to the bond they form with phosphate and ammonium, struvite crystal nuclei are formed.

The precipitating struvite cannot be discharged from the reactor in its entirety, in particular in the case of reaction spaces or channels that are long in the direction of flow, and the crystals remaining in the reaction channel grow. At a certain point in time, this causes a blockage in the reactor, i.e. the reactor becomes clogged.

Finally, in order to cause the electrolyte to flow over the full width of the electrode, distributor elements must be installed at the reactor inlet in order to distribute the flow. However, there is a risk of struvite accumulating between the distributor elements and in the holes of the distributor elements. As a result, deposits in the reaction channel are not rinsed out as well, since individual holes in the distributor are blocked and the flow through the reaction channel no longer takes place across the full width thereof. In addition, these blockages hinder the inflow to the reactor and thus the actual release of the ions.

### SUMMARY OF THE INVENTION

The object of the invention is to provide an electrolytic reactor, in particular for separating phosphate from phosphate-containing liquids or process water and recovering said phosphate as phosphate salts, which avoids the above-mentioned disadvantages and, in particular, ensures a safe reaction process which results in a lower risk of struvite deposits, while also preventing unwanted electrolysis of metal components such as contact elements.

The invention is achieved by means of a device having the features herein. Advantageous developments and embodiments of the invention are also described herein.

The electrolytic reactor comprises an inlet for the process water to be treated (electrolyte) and a flow channel adjoining same, a magnesium metering unit comprising two electrodes of different polarity being arranged in the flow channel, at least one of the two electrodes being a sacrificial electrode. In this case, the magnesium metering unit is designed as a free-level reactor and a mixing/sedimentation unit is connected downstream of the magnesium metering unit in the direction of flow, said mixing/sedimentation unit having an inlet (feed) for the phosphate-containing process water and an outlet for the depleted process water and for the obtained phosphate product. In this way, by separating the electrolysis zone and a mixing zone with addition of the phosphate-containing feed flow and subsequent sedimentation zone for the products, in particular in the form of struvite crystals, clogging of the reactor or electrolysis zone by means of struvite crystals is avoided and thus a longer operating time without maintenance and interruptions is made possible.

In order to achieve sufficient depletion of phosphate at high phosphate concentrations in the inlet, the process water can be recirculated by mixing with the feed after the crystals have been deposited.

Furthermore, the design as a free-level reactor, i.e. with an open liquid level, offers more freedom of design for the contacting than a pressure reactor. The problems of the overflow over the electrodes and thus their uncontrolled consumption is avoided.

It is particularly advantageous if the sacrificial electrode is only in contact with the electrolysis liquid in regions, a contact of the sacrificial anode being arranged above the liquid level. This is made possible by the design as a free-level reactor. For example, it is possible for the contact to be arranged in such a way that contacting takes place in the dry region of the electrodes, in particular at the upper end of the sacrificial electrode remote from the electrolysis liquid, and the electrode dips only slightly into the electrolysis liquid. In this way, released magnesium ions can be passed directly to the mixing/sedimentation unit and mixed there in a mixing zone with the phosphate-containing feed flow, such that the product is formed, in particular struvite.

It is possible for the sacrificial anode to be formed from electrode bars, in particular from magnesium bars, which are arranged in a vertical chute and are in particular held in a spring-loaded manner in the direction of the flow channel. Advantageously, the upper electrode in the operating state can be movable and can be adjusted to the lower electrode in order to maintain a constant height of the reaction space. In this way, the electrode can be lowered during consumption, such that there is constant contact with the electrolysis liquid at all times. The electrode bars may preferably be rectangular but also, in particular, trapezoidal in cross section, with their oblique sides arranged so as to complement one another. In the case of electrode bars, the bar furthest away from the electrolysis zone, i.e. from the region in contact with the electrolysis liquid, or the electrolysis gap, can be electrically contacted. By using a plurality of bars in a chute, the operating time is increased, but at the same time the flexibility is maintained due to the use of a plurality of electrodes that are easy to handle. In particular, electrodes can be loaded without complicated disassembly of the reactor by installing new electrodes in the chute.

In order to provide a gap for the electrolysis at a defined height, the sacrificial anode may be supported on a spacer so as to form the electrolysis gap in which the electrolysis zone is located. The spacer may, in particular, be formed from plastics ribs such that it does not experience any corrosion or reaction.

Preferably, the length of the magnesium metering unit in the direction of flow is much shorter than the flow channel, in particular at most half as long, in particular at most one third as long and, more particularly, at most one quarter as long. The flow channel has the task of distributing the flow uniformly to the channel width or the width of the reactor chamber. Since the actual reaction does not take place, as before, in the region of the electrolysis and of the electrodes, this region can be designed to be comparatively short, which reduces the risk of impurities and deposits.

In this case, the actual reaction zone extends from the output-side end of the flow channel into the mixing zone of the mixing/sedimentation unit. It is advantageous that the crystals formed can sediment downward over the entire reactor width and then be removed there. Particularly advantageously, the mixing/sedimentation unit has a mixing zone for this purpose, which is adjoined below by a sedimentation zone, which in particular tapers in a funnel-like manner downward. However, a round funnel shape or pyramid shape is also conceivable in this case. If a plurality of mixing/sedimentation units are provided one next to the other because a plurality of reactors are connected in parallel, they can be connected so as to form a single channel-like unit. The unit can then have one or more outlets for the product.

In the mixing zone, the electrolysis liquid charged by the electrolysis is mixed by means of the inflow of the feed flow and a reaction with subsequent sedimentation is thus provided over the entire cross section of the mixing/sedimentation unit.

The above is reinforced by the fact that the distance between the magnesium metering unit and the mixing/sedimentation unit in the direction of flow is much shorter than the flow channel, in particular at most half as long, in particular at most one third as long and, more particularly, at most one quarter as long.

Preferably, the flow cross section in the magnesium metering unit is much wider than it is high, in particular the ratio of height to width is at least 1:50, preferably at least 1:70 and more preferably at least 1:100. In this way, particularly good charging of the electrolysis liquid with ions, preferably magnesium ions, is achieved.

Advantageously, the flow cross section of the magnesium metering unit may have a rectangular cross section in the direction of flow and a constant flow cross section over the entire region of the magnesium metering unit. This results in a uniform electrolysis rate.

Favorable guidance and resulting charging of the electrolysis liquid is achieved when the inlet for the electrolysis liquid has a circular cross section and, in the flow channel upstream of the magnesium metering unit, the cross section transitions into a rectangular cross section that is larger, in particular much larger, than the circular cross section. This produces a desired uniform flow. The rectangular cross section is preferably at least twice, more preferably at least four times and further preferably at least ten times, as large as the circular cross section.

The magnesium is then metered into the electrolysis liquid in the magnesium metering unit by means of the electrodes under voltage. The electrolysis liquid may be a filtrate which, for example, can be circulated (recirculated).

For electrodes made of magnesium-containing material, it is generally provided that the following reaction occurs when phosphorus is reacted:

Mg²⁺+NH₄⁺+PO₄³⁻+6H₂O→MgNH₄PO₄-6H₂O,

the magnesium ions being released from magnesium on the surface of a sacrificial anode. In this case, the electrodes lead to the electrolytic recovery of phosphorus as crystallized magnesium ammonium phosphate (MAP) (struvite) in the event of lack of magnesium in the initial substrate.

If one of the two electrodes or both electrodes is consumed during the reaction, it is advantageous if, as described, the distance between the electrodes always remains constant, and as a result the electrical field between the anode and cathode always remains constant and thus optimal reaction rates can be achieved. With regard to deposits, it is advantageous if none of the two electrodes is used permanently as the cathode or anode, but instead a brief reversal of polarity always takes place at particular intervals. Without polarity reversal, deposits can form on the cathode. As a result of the polarity reversal, these deposits are removed with consumption of the anode and can be discharged from the reactor with the liquid flow. If it is not provided according to the invention that both electrodes are provided as a sacrificial electrode, it is preferred that the cathode, which is not consumed, is produced from stainless steel or another corrosion-resistant electrically conductive material.

It is of particular importance for process management that a constant distance between the surfaces of the anode and the cathode is independent of the consumption of the relevant sacrificial electrode and this is preferably equal over the entire area of the electrodes. The surfaces which delimit the electrolysis zone through which the electrolysis liquid flows are preferably planar, the reaction space preferably having a rectangular cross section in the direction of flow and, moreover, the electrodes also having a cubic shape or, in a plan view, a rectangular shape that is not substantially changed by the consumption. The constant geometry of the reaction space keeps the electrical field constant even during consumption of the electrodes, and defined and high reaction rates can be achieved with minimal energy use. The electrolysis gap remains the same over the entire flow length, in particular constant in width and height.

One electrode can be adjusted to the other electrode, for example with the aid of gravity, but also with the aid of one or more springs and/or one or more actuators. If gravity is used, for example, to adjust an upper electrode to a lower electrode in the operating state, electrical, pneumatic or hydraulic actuators may also be used in addition to gravity or springs.

Furthermore, it is also possible, in particular when actuators are provided for adjusting an electrode, to provide a closed-loop or open-loop distance controller for the distance between the electrodes, using sensors which detect the consumption or the remaining thickness of one or both electrodes as part of a control loop. Sensors are known on the market for this purpose.

Advantageously, a plurality of metering units may be connected to and interact with a mixing/sedimentation unit.

Advantageously, a plurality of reactors may also be connected in parallel and combined via a common separation.

Furthermore, it is possible to provide means for detecting the position of the electrodes in order to be able to detect the process taking place in the reactor and the consumption of the sacrificial electrodes. These may, for example, be position sensors in any design. They may preferably be fastened movably on the housing of the reactor or on the electrode. The consumption of the electrodes can thus be monitored in a simple and very reliable manner.

Finally, means for detecting the electrical current flowing between the electrodes and/or the electrical voltage applied between the electrodes are also possible. As a result, the process taking place in the reactor can be monitored easily and reliably. Any disruptions to the process lead to a change in the electrical current and/or the electrical voltage and can thus be easily detected.

Particularly preferably, the sacrificial electrode consists of a magnesium-containing material. More or less pure magnesium may also be provided as an electrode material. The second electrode may be made of stainless steel, since this material is electrically conductive and is not corroded by the process water to be treated in the reactor.

### BRIEF DESCRIPTION OF THE DRAWINGS

Further advantages and advantageous embodiments of the invention are shown in the following drawing, in which:

FIG. 1a: is a sectional representation of a first embodiment;

FIG. 1b: is a plan view of the reactor according to FIG. 1a;

FIG. 2a-d: show an alternative embodiment of the reactor;

FIG. 3a-c: show another alternative embodiment of the reactor.

### DESCRIPTION OF THE PREFERRED EMBODIMENTS

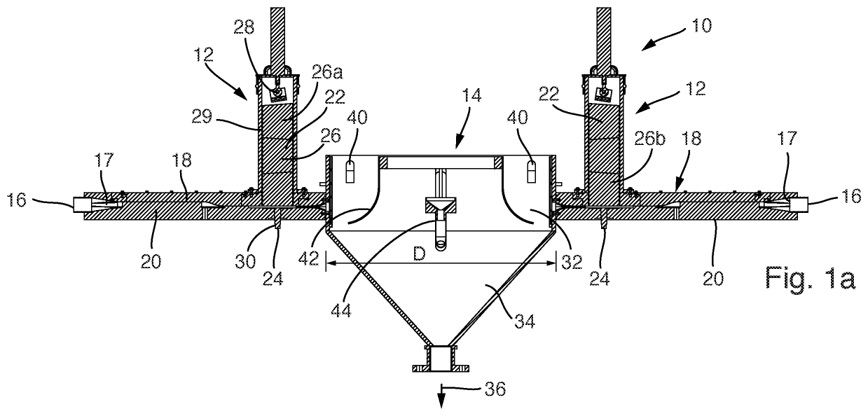

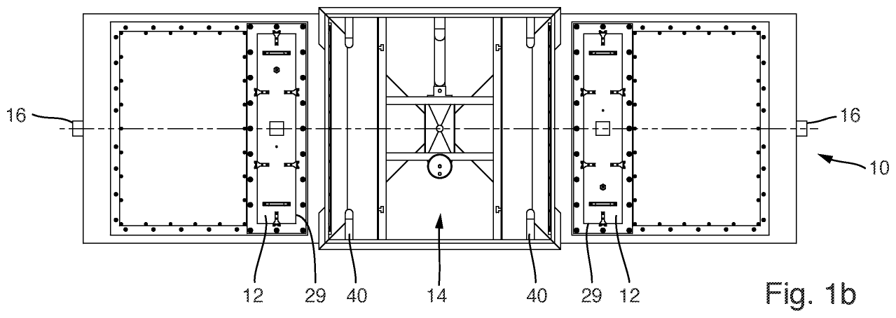

FIGS. 1a and 1b show a first reactor according to the invention. The reactor is an electrolytic reactor and is provided as a whole with the reference sign 10. The reactor comprises two magnesium metering units 12 and a mixing/sedimentation unit 14. The two magnesium metering units 12 are arranged on opposite sides of the mixing/sedimentation unit 14. An inlet 16 is provided in each case, which transitions via a first flow portion 17 from a circular to a rectangular cross section. In another flow portion 18, the rectangular cross section changes in height and width in order to then transition into the magnesium metering unit 12 in the course of the flow channel 20. As a result, the flow is homogenized and the smallest possible height of the flow cross section relative to the width is achieved in order to be able to electrolytically meter in the largest possible amount of magnesium. Furthermore, two electrodes 22 and 24 are provided, which enclose between them the flow channel 20 at least in portions, the upper electrode 22 being designed as a sacrificial electrode and preferably consisting of trapezoidal magnesium bars 26, which complement one another with their oblique side surfaces. The electrode 22 is loaded in the direction of the flow channel 20 by means of a resilient element (not shown). The magnesium bars 26 are received in a chute 29 that can be filled from above. The electrical contacting of the electrode 22 takes place via a contact element 28 which engages and is contacted at the uppermost electrode bar designated here with 26a.

The magnesium metering unit 12 provides an electrolysis zone or an electrolysis gap and is open with respect to the environment, and therefore it is not a pressure reactor but rather a free-level reactor. The lowermost of the electrode bars 26b projects with its lower end into the flow channel 20 and is wetted there by the electrolysis liquid flowing through the flow channel 20, such that magnesium ions pass into the electrolysis liquid by means of the electrolysis and the electrode 22 is consumed. The electrode 22 is always adjusted in the direction of the flow channel 20 by means of spring loading (not shown here).

To keep the cross section of the flow channel 20 constant, a spacer (not shown) is provided, preferably made of plastics ribs, on which the lowermost electrode bar 26b is supported. In the exit of the flow channel 20 and in the entrance into the mixing/sedimentation unit 14, the magnesium is then reacted with the phosphorus and the ammonium of a phosphate-containing feed flow, the inlets for which are provided with the reference sign 40. The feed flow is metered in at all corners of the pyramid-shaped, downwardly tapering mixing and sedimentation unit 14. The mixing/sedimentation unit 14 comprises a mixing zone 32, in which a feed flow is fed, and a sedimentation zone 34. The mixing of the electrolysis liquid, in particular of a filtrate, with the feed flow results in a reaction taking place over the entire cross-sectional area D of the mixing/sedimentation device 14 and the product produced falls in the direction of the arrow 36 and can be collected. The product is filtered and the liquid is recirculated.

In particular, in this way, no electrical contact 28, 30 of the electrodes 22, 24 comes into contact with the liquid, thereby reducing the risk of corrosion. Furthermore, the actual zone in which magnesium ions are metered in is very short, and therefore no deposits are to be expected in this region. Indeed, a substantial part of the reaction only takes place in the mixing/sedimentation unit, and can then immediately reach the sedimentation zone 34 from the mixing zone 32 as a product. In this way, the operating time of the reactor can be significantly prolonged.

In order to prevent further deposits, brief polarity reversals of the electrodes 22, 24 may also be carried out, as a result of which deposits on the cathode are introduced with the liquid flow into the container of the mixing/sedimentation unit 14. It is particularly preferred if the region covered by the electrodes 22, 24 in the flow channel 20 for forming the magnesium metering unit 12 is much shorter in the direction of flow than the total length of the flow channel 20. In particular, this region may constitute less than ¼ of the length of the entire flow channel 20. Furthermore, the portion downstream of the metering unit 12 as far as the mixing/sedimentation unit 14 is also much shorter than the total length of the flow channel 20. In this way, it is ensured that the reaction and thus also the formation of struvite crystals only take place in the mixing/sedimentation unit 14. In the manner described, problems which have occurred in practice with corresponding reactors can be avoided.

The electrolysis gap between the two electrodes 22 and 24 is preferably designed such that the length of the electrolysis zone is much longer than the height of the gap S. In particular, the gap height S is also much smaller than the width B of the electrodes 22, 24. In particular, a height/length ratio of 1:150 and a height/width ratio of at least 1:100 are provided here. In this way, good electrolysis rates are achieved. In this case, the gap has a rectangular cross section which is in particular larger, in particular much larger, than the circular cross section of the inlet 16. This can be clearly seen in FIG. 1b.

If the flow flows with as uniform a flow cross section as possible and as simultaneously as possible into the electrolysis zone, particularly good rates can be achieved over the electrolysis zone.

Furthermore, the feed flow 40 is fed in via baffles 42, which ensure uniform input. The flow guide walls are used to produce an eddy, which is generated by the flow 16 exiting from the reaction space. The feed flow 40 is mixed therein.

Finally, an outlet 44 is provided, which serves in particular to adjust the fill level in the mixing and sedimentation unit 14.

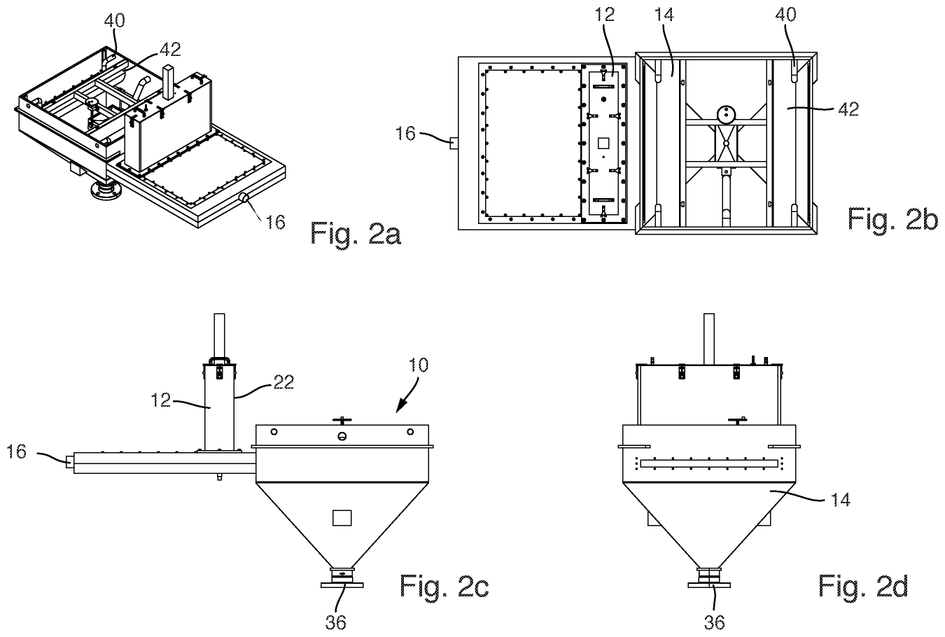

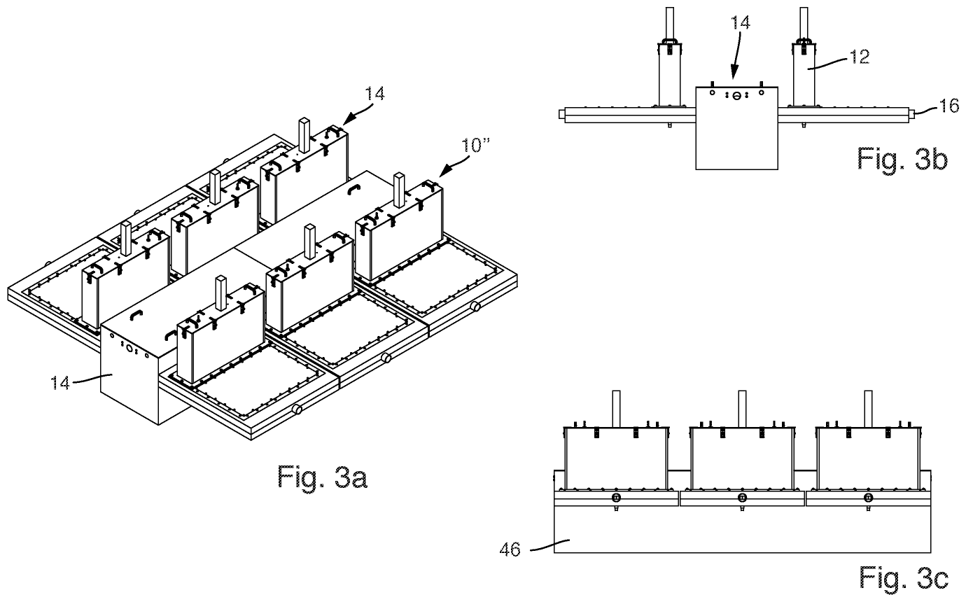

FIGS. 2 and 3 show analogous designs, FIG. 2 differing in that the supply by means of the inlet 16 takes place only from one side. Otherwise, the reactor 10′ is constructed in an identical manner to the reactor according to FIG. 1.

The reactor 10″ comprises three reactors 10 according to FIG. 1, which are connected in parallel and each have two inlets 16. The mixing and sedimentation units 14 are formed continuously as a channel 46, as can be seen in FIG. 3b. Alternatively, these may also be designed separately and may each be funnel-shaped. The metering units 12 are each formed separately. In this way, the reactors 10 can be adapted to the respective requirements in terms of size.

1. An electrolytic reactor, in particular for separating phosphate from phosphate-containing liquids and/or recovering phosphate salts, comprising an inlet (16) for an electrolysis liquid and a flow channel (20) adjoining same, a magnesium metering unit (12) comprising two electrodes (22, 24) of different polarity being arranged in the flow channel (20), at least one of the two electrodes (22, 24) being a sacrificial electrode (22), wherein the magnesium metering unit (12) is designed as a free-level reactor and a mixing/sedimentation unit (14) being connected downstream of the magnesium metering unit (12) in the direction of flow, said mixing/sedimentation unit having a feed inlet (40) for the phosphate-containing liquids and an outlet (36) for the purified liquid and for the obtained phosphate product.

2. The reactor according to claim 1, wherein the sacrificial electrode (22) is only in contact with the electrolysis liquid in regions, a contact (28) of the sacrificial anode (22) being arranged above a liquid level.

3. The reactor according to claim 1, wherein the sacrificial anode (22) is formed from electrode bars (26), in particular from magnesium bars, which are arranged in a vertical chute (29) and are in particular held in a spring-loaded manner in the direction of the flow channel (20).

4. The reactor according to claim 1, wherein the sacrificial anode (22) is supported on a spacer so as to form the electrolysis gap, and the spacer is, in particular, formed from plastics ribs.

5. The reactor according to claim 1, wherein the length of the magnesium metering unit (12) in the direction of flow is much shorter than the flow channel (20), in particular at most half as long, in particular at most one third as long and, more particularly, at most one quarter as long.

6. The reactor according to claim 1, wherein the distance between the magnesium metering unit (12) and the mixing/sedimentation unit (14) in the direction of flow is much shorter than the flow channel (20), in particular at most half as long, in particular at most one third as long and, more particularly, at most one quarter as long.

7. The reactor according to claim 1, wherein the flow cross section in the magnesium metering unit (12) is much wider than it is high, in particular the ratio of height to width is at least 1:50, preferably at least 1:70 and more preferably at least 1:100.

8. The reactor according to claim 1, wherein the flow cross section of the magnesium metering unit (12) has a rectangular cross section in the direction of flow and a constant flow cross section over the entire region of the magnesium metering unit (28).

9. The reactor according to claim 1, wherein the upper electrode (22) in the operating state is movable and can be adjusted to the lower electrode (24) in order to maintain a constant height (S) of the electrolysis gap.

10. The reactor according to claim 1, wherein the inlet (16) for the electrolysis liquid has a circular cross section (17) and, in the flow channel (20) upstream of the magnesium metering unit (12), the cross section transitions into a rectangular cross section that is larger, in particular much larger, than the circular cross section.

11. The reactor according to claim 1, wherein the mixing and sedimentation unit (14) is funnel-shaped, in particular pyramid-shaped, or is designed as channels (46) that taper downward.

12. The reactor according to claim 2, wherein the sacrificial anode (22) is supported on a spacer so as to form the electrolysis gap, and the spacer is, in particular, formed from plastics ribs.

13. The reactor according to claim 12, wherein the length of the magnesium metering unit (12) in the direction of flow is much shorter than the flow channel (20), in particular at most half as long, in particular at most one third as long and, more particularly, at most one quarter as long.

14. The reactor according to claim 4, wherein the length of the magnesium metering unit (12) in the direction of flow is much shorter than the flow channel (20), in particular at most half as long, in particular at most one third as long and, more particularly, at most one quarter as long.

15. The reactor according to claim 3, wherein the length of the magnesium metering unit (12) in the direction of flow is much shorter than the flow channel (20), in particular at most half as long, in particular at most one third as long and, more particularly, at most one quarter as long.

16. The reactor according to claim 2, wherein the length of the magnesium metering unit (12) in the direction of flow is much shorter than the flow channel (20), in particular at most half as long, in particular at most one third as long and, more particularly, at most one quarter as long.

17. The reactor according to claim 13, wherein the distance between the magnesium metering unit (12) and the mixing/sedimentation unit (14) in the direction of flow is much shorter than the flow channel (20), in particular at most half as long, in particular at most one third as long and, more particularly, at most one quarter as long.

18. The reactor according to claim 14, wherein the distance between the magnesium metering unit (12) and the mixing/sedimentation unit (14) in the direction of flow is much shorter than the flow channel (20), in particular at most half as long, in particular at most one third as long and, more particularly, at most one quarter as long.

19. The reactor according to claim 15, wherein the distance between the magnesium metering unit (12) and the mixing/sedimentation unit (14) in the direction of flow is much shorter than the flow channel (20), in particular at most half as long, in particular at most one third as long and, more particularly, at most one quarter as long.

20. The reactor according to claim 16, wherein the distance between the magnesium metering unit (12) and the mixing/sedimentation unit (14) in the direction of flow is much shorter than the flow channel (20), in particular at most half as long, in particular at most one third as long and, more particularly, at most one quarter as long.
